(19) United States
(12) Patent Application Publication
(10) Pub. No.: US 2012/0213303 A1
(43) Pub. Date: Aug. 23, 2012

(54) COMPATIBLE SUBSET GENERATION TO FACILITATE MULTI-RADIO COEXISTENCE

(75) Inventors: Tamer Adel Kadous, San Diego, CA (US); Ashok Mantravadi, San Diego, CA (US)

(73) Assignee: QUALCOMM INCORPORATED, San Diego, CA (US)

(21) Appl. No.: 13/210,995

(22) Filed: Aug. 16, 2011

Related U.S. Application Data
(60) Provisional application No. 61/374,437, filed on Aug. 17, 2010.

(51) Int. Cl. H04B 7/02

(52) U.S. Cl. 375/267

(57) ABSTRACT

Radios in a multi-radio device may be represented by parameter nodes, each parameter node representing a communication configuration of a particular radio. A coexistence manager may determine compatible subsets of parameter nodes. The subsets represent communication configurations of the radios that are compatible for simultaneous operation which reduces interference. Compatible subset generation may occur during an evaluation phase of a coexistence manager of a multi-radio device. Compatible subsets are generated based on resolvability of radio events or other potential collisions of the subsets, such as by use of a progressive resolution (PR) graph, associated compatibility graphs, and instructions and logic corresponding to such graphs.

### CROSS REFERENCE TO RELATED APPLICATION

This application claims the benefit of U.S. provisional patent application No. 61/374,437 filed Aug. 17, 2010, in the names of KADOUS et al., the disclosure of which is expressly incorporated herein by reference in its entirety.

### TECHNICAL FIELD

The present description is related, generally, to multi-radio techniques and, more specifically, to coexistence techniques for multi-radio devices.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple out (MIMO) system.

Some conventional advanced devices include multiple radios for transmitting/receiving using different Radio Access Technologies (RATs). Examples of RATs include, e.g., Universal Mobile Telecommunications System (UMTS), Global System for Mobile Communications (GSM), cdma2000, WiMAX, WLAN (e.g., WiFi), Bluetooth, LTE, and the like.

An example mobile device includes an LTE User Equipment (UE), such as a fourth generation (4G) mobile phone. Such 4G phone may include various radios to provide a variety of functions for the user. For purposes of this example, the 4G phone includes an LTE radio for voice and data, an IEEE 802.11 (WiFi) radio, a Global Positioning System (GPS) radio, and a Bluetooth radio, where two of the above or all four may operate simultaneously. While the different radios provide useful functionalities for the phone, their inclusion in a single device gives rise to coexistence issues. Specifically, operation of one radio may in some cases interfere with operation of another radio through radiative, conductive, resource collision, and/or other interference mechanisms. Coexistence issues include such interference.

This is especially true for the LTE uplink channel, which is adjacent to the Industrial Scientific and Medical (ISM) band and may cause interference therewith It is noted that Bluetooth and some Wireless LAN (WLAN) channels fall within the ISM band. In some instances, a Bluetooth error rate can become unacceptable when LTE is active in some channels of Band 7 or even Band 40 for some Bluetooth channel conditions. Even though there is no significant degradation to LTE, simultaneous operation with Bluetooth can result in disruption in voice services terminating in a Bluetooth headset. Such disruption may be unacceptable to the consumer. A similar issue exists when LTE transmissions interfere with GPS. Currently, there is no mechanism that can solve this issue since LTE by itself does not experience any degradation

With reference specifically to LTE, it is noted that a UE communicates with an evolved NodeB (eNB; e.g., a base station for a wireless communications network) to inform the eNB of interference seen by the UE on the downlink. Furthermore, the eNB may be able to estimate interference at the UE using a downlink error rate. In some instances, the eNB and the UE can cooperate to find a solution that reduces interference at the UE, even interference due to radios within the UE itself However, in conventional LTE, the interference estimates regarding the downlink may not be adequate to comprehensively address interference.

In one instance, an LTE uplink signal interferes with a Bluetooth signal or WLAN signal. However, such interference is not reflected in the downlink measurement reports at the eNB. As a result, unilateral action on the part of the UE (e.g., moving the uplink signal to a different channel) may be thwarted by the eNB, which is not aware of the uplink coexistence issue and seeks to undo the unilateral action. For instance, even if the UE re-establishes the connection on a different frequency channel, the network can still handover the UE back to the original frequency channel that was corrupted by the in-device interference. This is a likely scenario because the desired signal strength on the corrupted channel may sometimes be higher be reflected in the measurement reports of the new channel based on Reference Signal Received Power (RSRP) to the eNB. Hence, a ping-pong effect of being transferred back and forth between the corrupted channel and the desired channel can happen if the eNB uses RSRP reports to make handover decisions.

Other unilateral action on the part of the UE, such as simply stopping uplink communications without coordination of the eNB may cause power loop malfunctions at the eNB. Additional issues that exist in conventional LTE include a general lack of ability on the part of the UE to suggest desired configurations as an alternative to configurations that have coexistence issues. For at least these reasons, uplink coexistence issues at the UE may remain unresolved for a long time period, degrading performance and efficiency for other radios of the UE.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a multiple access wireless communication system according to one aspect.

FIG. 2 is a block diagram of a communication system according to one aspect.

FIG. 3 illustrates an exemplary frame structure in downlink Long Term Evolution (LTE) communications.

FIG. 4 is a block diagram conceptually illustrating an exemplary frame structure in uplink Long Term Evolution (LTE) communications.

FIG. 5 illustrates an example wireless communication environment.

FIG. 6 is a block diagram of an example design for a multi-radio wireless device.

FIG. 7 is graph showing respective potential collisions between seven example radios in a given decision period.

FIG. 8 is a diagram showing operation of an example Coexistence Manager (CxM) over time.

FIG. 9 is a block diagram illustrating adjacent frequency bands.

FIG. 10 is a block diagram of a system for providing support within a wireless communication environment for multi-radio coexistence management according to one aspect of the present disclosure.

FIG. 11 is a block diagram of a system for compatible subset generation according to one aspect of the present disclosure.

FIG. 12 illustrates a progressive resolution node graph according to one aspect of the present disclosure.

FIG. 13A illustrates the generation of a compatibility graph according to one aspect of the present disclosure.

FIG. 13B illustrates the generation of a compatibility graph according to one aspect of the present disclosure.

FIG. 13C illustrates the generation of a compatibility graph according to one aspect of the present disclosure.

FIG. 13D illustrates the generation of a compatibility graph according to one aspect of the present disclosure.

FIG. 13E illustrates the generation of a compatibility graph according to one aspect of the present disclosure.

FIG. 14 is a block diagram illustrating compatible subset generation according to one aspect of the present disclosure.

FIG. 15 is a block diagram illustrating compatible subset generation according to one aspect of the present disclosure.

### SUMMARY

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

Offered is a method of wireless communication. The method includes determining a set of radios of a multi-radio device that may potentially interfere with each other. The method also includes representing the set of radios as a set of parameter nodes. Each parameter node represents a communication configuration of one of the set of radios. The method further includes determining a subset of parameter nodes. The subset includes parameter nodes representing radio communication configurations that are compatible with each other.

Offered is an apparatus for wireless communication. The apparatus includes means for determining a set of radios of a multi-radio device that may potentially interfere with each other. The apparatus also includes means for representing the set of radios as a set of parameter nodes. Each parameter node represents a communication configuration of one of the set of radios. The apparatus further includes means for determining a subset of parameter nodes. The subset includes parameter nodes representing radio communication configurations that are compatible with each other.

Offered is a computer program product configured for wireless communication. The computer program product includes a non-transitory computer-readable medium having non-transitory program code recorded thereon. The non-transitory program code includes program code to determine a set of radios of a multi-radio device that may potentially interfere with each other. The program code also includes program code to represent the set of radios as a set of parameter nodes. Each parameter node represents a communication configuration of one of the set of radios. The program code further includes program code to determine a subset of parameter nodes. The subset includes parameter nodes representing radio communication configurations that are compatible with each other.

Offered is an apparatus for wireless communication. The apparatus includes a memory and a processor(s) coupled to the memory. The processor(s) is configured to determine a set of radios of a multi-radio device that may potentially interfere with each other. The processor(s) is also configured to represent the set of radios as a set of parameter nodes Each parameter node represents a communication configuration of one of the set of radios. The processor(s) is further configured to determine a subset of parameter nodes. The subset includes parameter nodes representing radio communication configurations that are compatible with each other.

Offered is a method of wireless communication. The method includes determining a set of radios of a multi-radio device that may potentially interfere with each other. The method also includes representing a set of parameter nodes as a progressive resolution graph. Each parameter node represents a communication configuration of one of the set of radios. The method further includes representing the set of radios as a radio compatibility graph. Each radio node represents one of the set of radios. The method still further includes determining a subset of radio nodes based on at least one of the radio compatibility graph and the progressive resolution graph. The subset includes radio nodes representing radios that are compatible with each other.

Offered is an apparatus for wireless communication. The apparatus includes means for determining a set of radios of a multi-radio device that may potentially interfere with each other. The apparatus also includes means for representing a set of parameter nodes as a progressive resolution graph. Each parameter node represents a communication configuration of one of the set of radios. The apparatus further includes means for representing the set of radios as a radio compatibility graph. Each radio node represents one of the set of radios. The apparatus still further includes means for determining a subset of radio nodes based on at least one of the radio compatibility graph and the progressive resolution graph. The subset includes radio nodes representing radios that are compatible with each other.

Offered is a computer program product configured for wireless communication. The computer program product includes a non-transitory computer-readable medium having non-transitory program code recorded thereon. The program code includes program code to determine a set of radios of a multi-radio device that may potentially interfere with each other. The program code also includes program code to represent a set of parameter nodes as a progressive resolution graph. Each parameter node represents a communication configuration of one of the set of radios. The program code further includes program code to represent the set of radios as a radio compatibility graph. Each radio node represents one of the set of radios. The program code still further includes program code to determine a subset of radio nodes based on at least one of the radio compatibility graph and the progressive resolution graph. The subset includes radio nodes representing radios that are compatible with each other.

Offered is an apparatus for wireless communication. The apparatus includes a memory and a processor(s) coupled to the memory. The processor(s) is configured to determine a set of radios of a multi-radio device that may potentially interfere with each other. The processor(s) is also configured to represent a set of parameter nodes as a progressive resolution graph. Each parameter node represents a communication configuration of one of the set of radios. The processor(s) is further configured to represent the set of radios as a radio compatibility graph. Each radio node represents one of the set of radios. The processor(s) is still further configured to determine a subset of radio nodes based on at least one of the radio compatibility graph and the progressive resolution graph. The subset includes radio nodes representing radios that are compatible with each other.

### DETAILED DESCRIPTION

Various aspects of the disclosure provide techniques to mitigate coexistence issues in multi-radio devices, where significant in-device coexistence problems can exist between, e.g., the LTE and Industrial Scientific and Medical (ISM) bands (e.g., for BT/WLAN). As explained above, some coexistence issues persist because an eNB is not aware of interference on the UE side that is experienced by other radios. According to one aspect, the UE declares a Radio Link Failure (RLF) and autonomously accesses a new channel or Radio Access Technology (RAT) if there is a coexistence issue on the present channel. The UE can declare a RLF in some examples for the following reasons: 1) UE reception is affected by interference due to coexistence, and 2) the UE transmitter is causing disruptive interference to another radio. The UE then sends a message indicating the coexistence issue to the eNB while reestablishing connection in the new channel or RAT. The eNB becomes aware of the coexistence issue by virtue of having received the message.

The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network can implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in portions of the description below.

Single carrier frequency division multiple access (SC-FDMA), which utilizes single carrier modulation and frequency domain equalization is a technique that can be utilized with various aspects described herein. SC-FDMA has similar performance and essentially the same overall complexity as those of an OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for an uplink multiple access scheme in 3GPP Long Term Evolution (LTE), or Evolved UTRA.

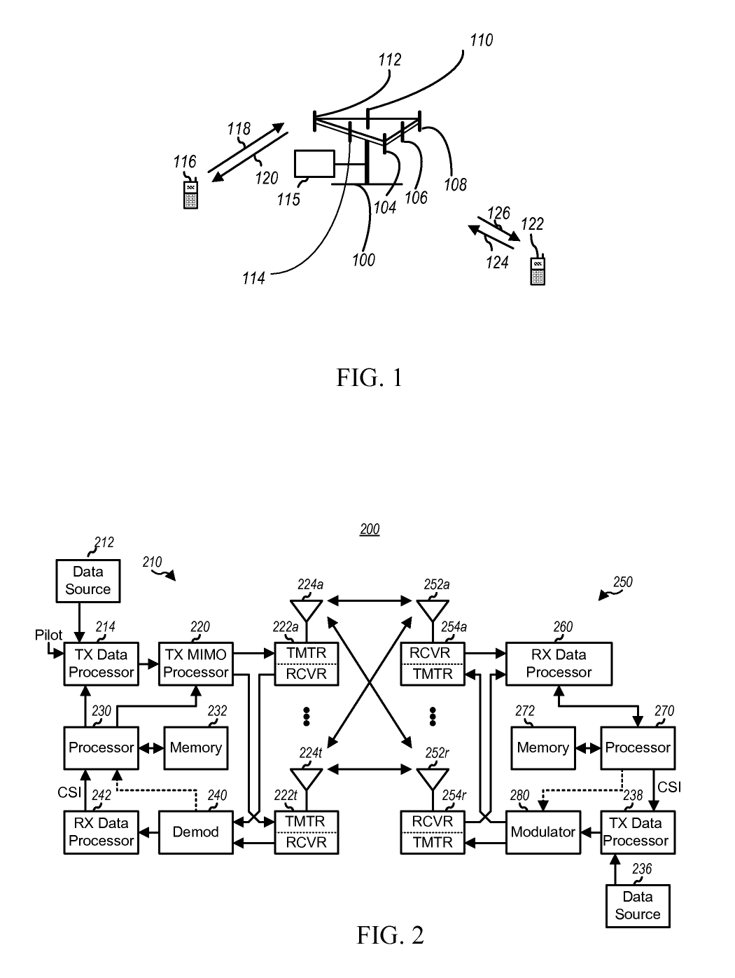

Referring to FIG. 1, a multiple access wireless communication system according to one aspect is illustrated. An evolved Node B 100 (eNB) includes a computer 115 that has processing resources and memory resources to manage the LTE communications by allocating resources and parameters, granting/denying requests from user equipment, and/or the like. The eNB 100 also has multiple antenna groups, one group including antenna 104 and antenna 106, another group including antenna 108 and antenna 110, and an additional group including antenna 112 and antenna 114. In FIG. 1, only two antennas are shown for each antenna group, however, more or fewer antennas can be utilized for each antenna group. A User Equipment (UE) 116 (also referred to as an Access Terminal (AT)) is in communication with antennas 112 and 114, while antennas 112 and 114 transmit information to the UE 116 over an uplink (UL) 188. The UE 122 is in communication with antennas 106 and 108, while antennas 106 and 108 transmit information to the UE 122 over a downlink (DL) 126 and receive information from the UE 122 over an uplink 124. In a frequency division duplex (FDD) system, communication links 118, 120, 124 and 126 can use different frequencies for communication. For example, the downlink 120 can use a different frequency than used by the uplink 118.

Each group of antennas and/or the area in which they are designed to communicate is often referred to as a sector of the eNB. In this aspect, respective antenna groups are designed to communicate to UEs in a sector of the areas covered by the eNB 100.

In communication over the downlinks 120 and 126, the transmitting antennas of the eNB 100 utilize beamforming to improve the signal-to-noise ratio of the uplinks for the different UEs 116 and 122. Also, an eNB using beamforming to transmit to UEs scattered randomly through its coverage causes less interference to UEs in neighboring cells than a UE transmitting through a single antenna to all its UEs.

An eNB can be a fixed station used for communicating with the terminals and can also be referred to as an access point, base station, or some other terminology. A UE can also be called an access terminal, a wireless communication device, terminal, or some other terminology.

FIG. 2 is a block diagram of an aspect of a transmitter system 210 (also known as an eNB) and a receiver system 250 (also known as a UE) in a MIMO system 200. In some instances, both a UE and an eNB each have a transceiver that includes a transmitter system and a receiver system. At the transmitter system 210, traffic data for a number of data streams is provided from a data source 212 to a transmit (TX) data processor 214.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, wherein N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) and frequency division duplex (FDD) systems. In a TDD system, the uplink and downlink transmissions are on the same frequency region so that the reciprocity principle allows the estimation of the downlink channel from the uplink channel. This enables the eNB to extract transmit beamforming gain on the downlink when multiple antennas are available at the eNB.

In an aspect, each data stream is transmitted over a respective transmit antenna. The TX data processor 214 formats, codes, and interleaves the traffic data for each data stream based on a particular coding scheme selected for that data stream to provide coded data.

The coded data for each data stream can be multiplexed with pilot data using OFDM techniques. The pilot data is a known data pattern processed in a known manner and can be used at the receiver system to estimate the channel response. The multiplexed pilot and coded data for each data stream is then modulated (e.g., symbol mapped) based on a particular modulation scheme (e.g., BPSK, QSPK, M-PSK, or M-QAM) selected for that data stream to provide modulation symbols. The data rate, coding, and modulation for each data stream can be determined by instructions performed by a processor 230 operating with a memory 232.

The modulation symbols for respective data streams are then provided to a TX MIMO processor 220, which can further process the modulation symbols (e.g., for OFDM). The TX MIMO processor 220 then provides N_{T} modulation symbol streams to N_{T} transmitters (TMTR) 222a through 222t. In certain aspects, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from the transmitters 222a through 222t are then transmitted from N_{T} antennas 224a through 224t, respectively.

At a receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{R} “detected” symbol streams. The RX data processor 260 then demodulates, deinterleaves, and decodes each detected symbol stream to recover the traffic data for the data stream. The processing by the RX data processor 260 is complementary to the processing performed by the TX MIMO processor 220 and the TX data processor 214 at the transmitter system 210.

A processor 270 (operating with a memory 272) periodically determines which pre-coding matrix to use (discussed below). The processor 270 formulates an uplink message having a matrix index portion and a rank value portion.

The uplink message can include various types of information regarding the communication link and/or the received data stream. The uplink message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by antennas 224, conditioned by receivers 222, demodulated by a demodulator 240, and processed by an RX data processor 242 to extract the uplink message transmitted by the receiver system 250. The processor 230 then determines which pre-coding matrix to use for determining the beamforming weights, then processes the extracted message.

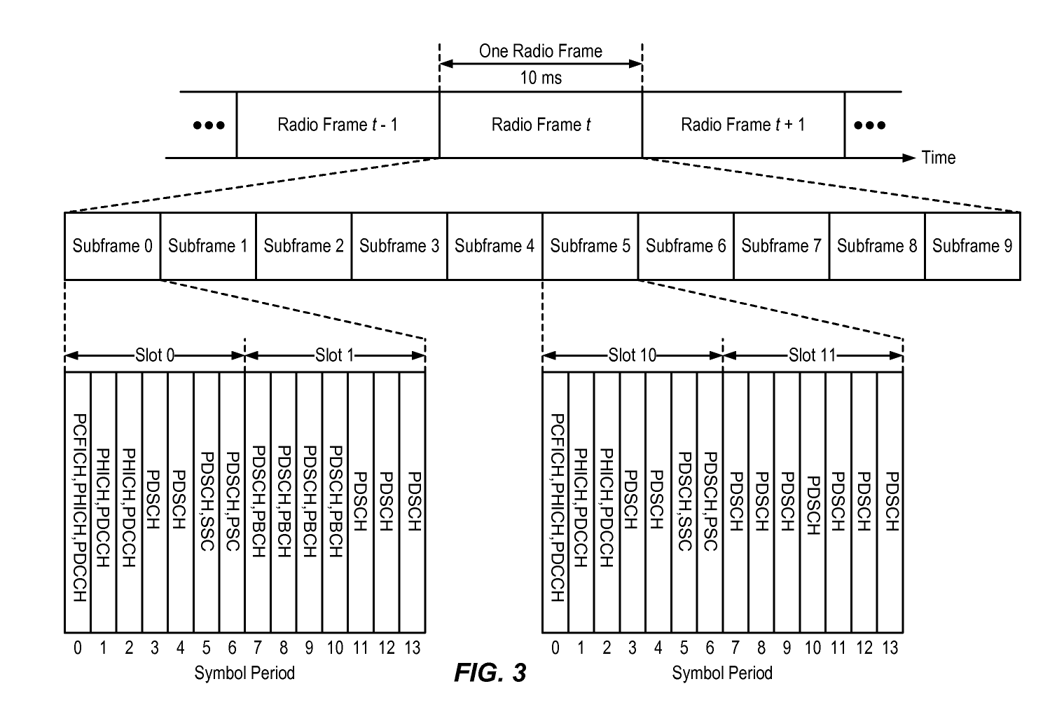

FIG. 3 is a block diagram conceptually illustrating an exemplary frame structure in downlink Long Term Evolution (LTE) communications. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 3) or 6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a Primary Synchronization Signal (PSS) and a Secondary Synchronization Signal (SSS) for each cell in the eNB. The PSS and SSS may be sent in symbol periods 6 and 5, respectively, in each of subframes 0 and 5 of each radio frame with the normal cyclic prefix, as shown in FIG. 3. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Cell-specific Reference Signal (CRS) for each cell in the eNB. The CRS may be sent in symbols 0, 1, and 4 of each slot in case of the normal cyclic prefix, and in symbols 0, 1, and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNB may send a Physical Control Format Indicator Channel (PCFICH) in the first symbol period of each subframe, as seen in FIG. 3. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 3, M=3. The eNB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 3. The PHICH may carry information to support Hybrid Automatic Repeat Request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

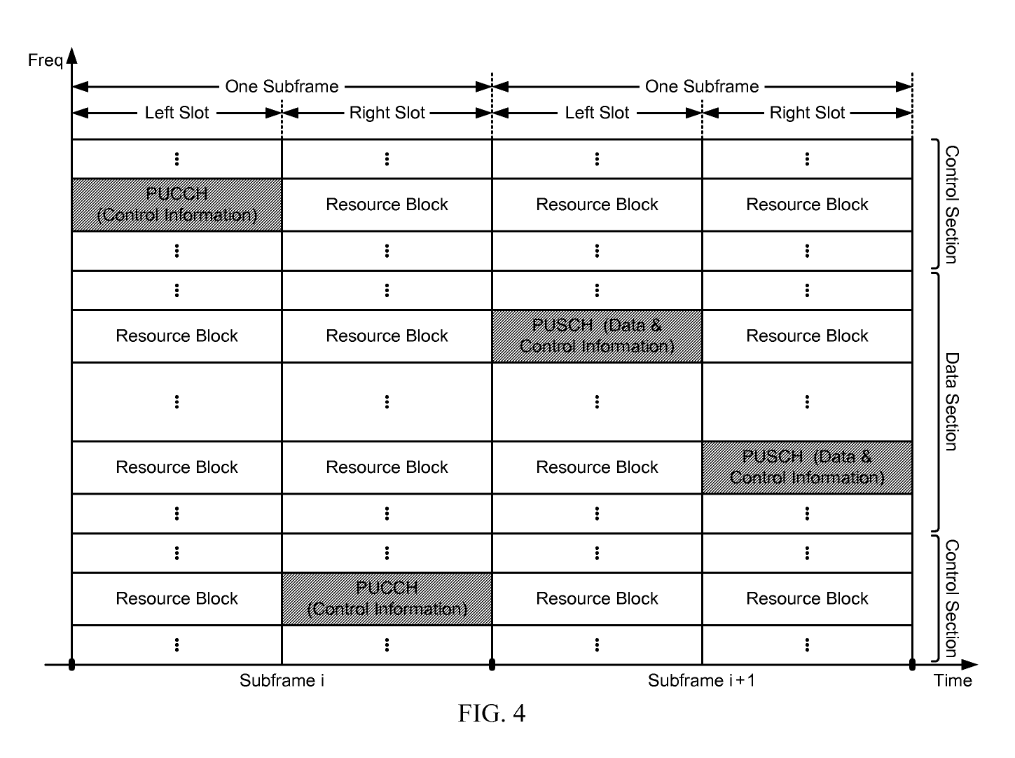

FIG. 4 is a block diagram conceptually illustrating an exemplary frame structure in uplink Long Term Evolution (LTE) communications. The available Resource Blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 4 results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNodeB. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in FIG. 4.

The PSS, SSS, CRS, PBCH, PUCCH and PUSCH in LTE are described in 3GPP TS 36.211, entitled “Evolved Universal Terrestrial Radio Access (E-UTRA); Physical Channels and Modulation,” which is publicly available.

In an aspect, described herein are systems and methods for providing support within a wireless communication environment, such as a 3GPP LTE environment or the like, to facilitate multi-radio coexistence solutions.

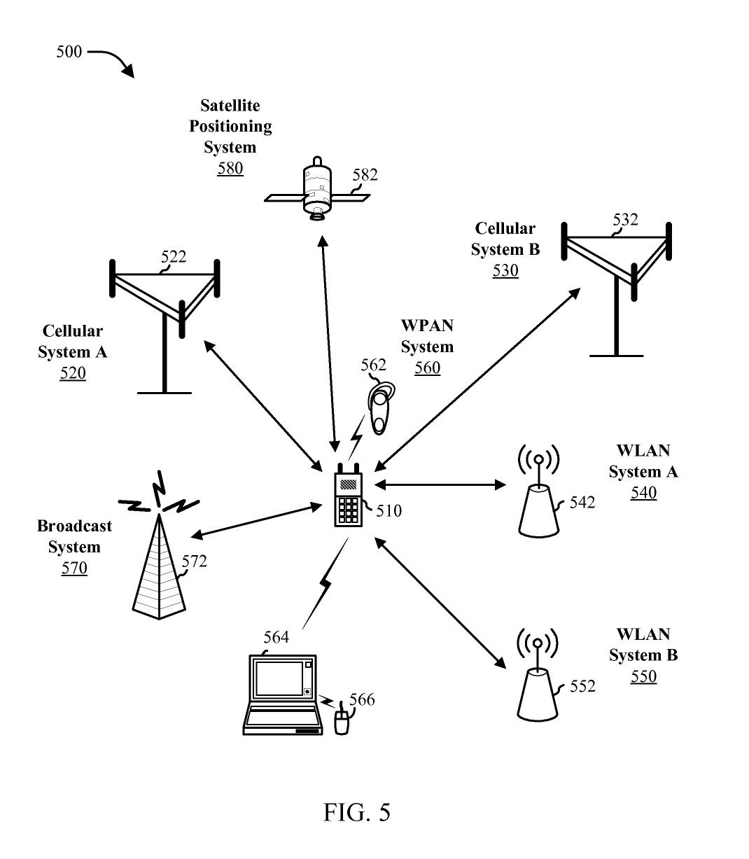

Referring now to FIG. 5, illustrated is an example wireless communication environment 500 in which various aspects described herein can function. The wireless communication environment 500 can include a wireless device 510, which can be capable of communicating with multiple communication systems. These systems can include, for example, one or more cellular systems 520 and/or 530, one or more WLAN systems 540 and/or 550, one or more wireless personal area network (WPAN) systems 560, one or more broadcast systems 570, one or more satellite positioning systems 580, other systems not shown in FIG. 5, or any combination thereof. It should be appreciated that in the following description the terms “network” and “system” are often used interchangeably.

The cellular systems 520 and 530 can each be a CDMA, TDMA, FDMA, OFDMA, Single Carrier FDMA (SC-FDMA), or other suitable system. A CDMA system can implement a radio technology such as Universal Terrestrial Radio Access (UTRA), cdma2000, etc. UTRA includes Wideband CDMA (WCDMA) and other variants of CDMA. Moreover, cdma2000 covers IS-2000 (CDMA2000 1X), IS-95 and IS-856 (HRPD) standards. A TDMA system can implement a radio technology such as Global System for Mobile Communications (GSM), Digital Advanced Mobile Phone System (D-AMPS), etc. An OFDMA system can implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3^{rd} Generation Partnership Project” (3GPP). cdma2000 and UMB are described in documents from an organization named “3^{rd} Generation Partnership Project 2” (3GPP2). In an aspect, the cellular system 520 can include a number of base stations 522, which can support bi-directional communication for wireless devices within their coverage. Similarly, the cellular system 530 can include a number of base stations 532 that can support bi-directional communication for wireless devices within their coverage.

WLAN systems 540 and 550 can respectively implement radio technologies such as IEEE 802.11 (WiFi), Hiperlan, etc. The WLAN system 540 can include one or more access points 542 that can support bi-directional communication. Similarly, the WLAN system 550 can include one or more access points 552 that can support bi-directional communication. The WPAN system 560 can implement a radio technology such as Bluetooth (BT), IEEE 802.15, etc. Further, the WPAN system 560 can support bi-directional communication for various devices such as wireless device 510, a headset 562, a computer 564, a mouse 566, or the like.

The broadcast system 570 can be a television (TV) broadcast system, a frequency modulation (FM) broadcast system, a digital broadcast system, etc. A digital broadcast system can implement a radio technology such as MediaFLO™, Digital Video Broadcasting for Handhelds (DVB-H), Integrated Services Digital Broadcasting for Terrestrial Television Broadcasting (ISDB-T), or the like. Further, the broadcast system 570 can include one or more broadcast stations 572 that can support one-way communication.

The satellite positioning system 580 can be the United States Global Positioning System (GPS), the European Galileo system, the Russian GLONASS system, the Quasi-Zenith Satellite System (QZSS) over Japan, the Indian Regional Navigational Satellite System (IRNSS) over India, the Beidou system over China, and/or any other suitable system. Further, the satellite positioning system 580 can include a number of satellites 582 that transmit signals for position determination.

In an aspect, the wireless device 510 can be stationary or mobile and can also be referred to as a user equipment (UE), a mobile station, a mobile equipment, a terminal, an access terminal, a subscriber unit, a station, etc. The wireless device 510 can be cellular phone, a personal digital assistance (PDA), a wireless modem, a handheld device, a laptop computer, a cordless phone, a wireless local loop (WLL) station, etc. In addition, a wireless device 510 can engage in two-way communication with the cellular system 520 and/or 530, the WLAN system 540 and/or 550, devices with the WPAN system 560, and/or any other suitable systems(s) and/or devices(s). The wireless device 510 can additionally or alternatively receive signals from the broadcast system 570 and/or satellite positioning system 580. In general, it can be appreciated that the wireless device 510 can communicate with any number of systems at any given moment. Also, the wireless device 510 may experience coexistence issues among various ones of its constituent radio devices that operate at the same time. Accordingly, device 510 includes a coexistence manager (CxM, not shown) that has a functional module to detect and mitigate coexistence issues, as explained further below.

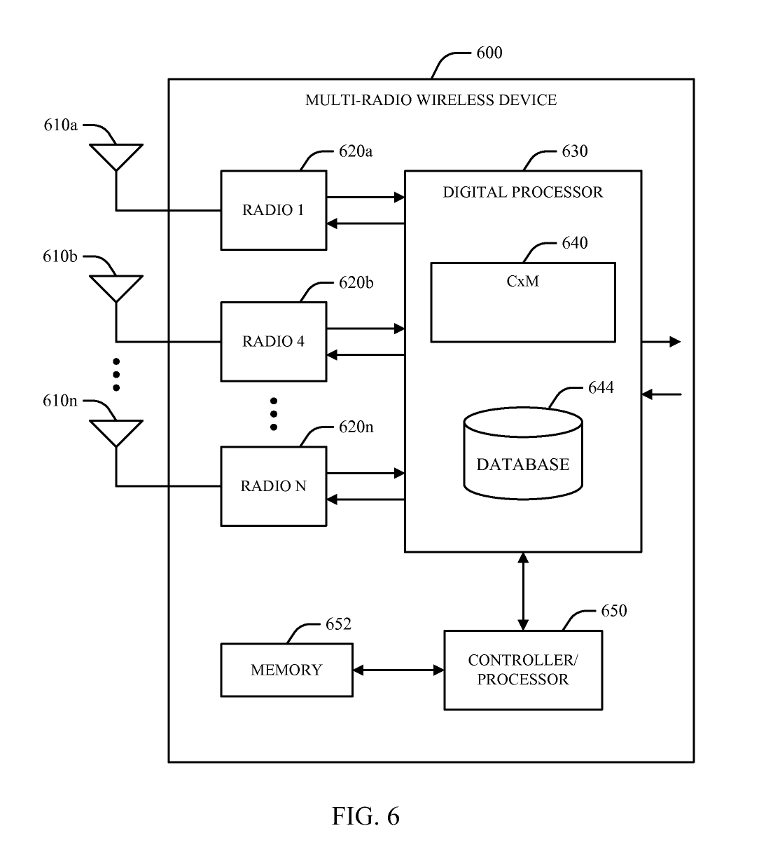

Turning next to FIG. 6, a block diagram is provided that illustrates an example design for a multi-radio wireless device 600 and may be used as an implementation of the radio 510 of FIG. 5. As FIG. 6 illustrates, the wireless device 600 can include N radios 620a through 620n, which can be coupled to N antennas 610a through 610n, respectively, where N can be any integer value. It should be appreciated, however, that respective radios 620 can be coupled to any number of antennas 610 and that multiple radios 620 can also share a given antenna 610.

In general, a radio 620 can be a unit that radiates or emits energy in an electromagnetic spectrum, receives energy in an electromagnetic spectrum, or generates energy that propagates via conductive means. By way of example, a radio 620 can be a unit that transmits a signal to a system or a device or a unit that receives signals from a system or device. Accordingly, it can be appreciated that a radio 620 can be utilized to support wireless communication. In another example, a radio 620 can also be a unit (e.g., a screen on a computer, a circuit board, etc.) that emits noise, which can impact the performance of other radios. Accordingly, it can be further appreciated that a radio 620 can also be a unit that emits noise and interference without supporting wireless communication.

In an aspect, respective radios 620 can support communication with one or more systems. Multiple radios 620 can additionally or alternatively be used for a given system, e.g., to transmit or receive on different frequency bands (e.g., cellular and PCS bands).

In another aspect, a digital processor 630 can be coupled to radios 620a through 620n and can perform various functions, such as processing for data being transmitted or received via the radios 620. The processing for each radio 620 can be dependent on the radio technology supported by that radio and can include encryption, encoding, modulation, etc., for a transmitter; demodulation, decoding, decryption, etc., for a receiver, or the like. In one example, the digital processor 630 can include a CxM 640 that can control operation of the radios 620 in order to improve the performance of the wireless device 600 as generally described herein. The CxM 640 can have access to a database 644, which can store information used to control the operation of the radios 620. As explained further below, the CxM 640 can be adapted for a variety of techniques to decrease interference between the radios. In one example, the CxM 640 requests a measurement gap pattern or DRX cycle that allows an ISM radio to communicate during periods of LTE inactivity.

For simplicity, digital processor 630 is shown in FIG. 6 as a single processor. However, it should be appreciated that the digital processor 630 can include any number of processors, controllers, memories, etc. In one example, a controller/processor 650 can direct the operation of various units within the wireless device 600. Additionally or alternatively, a memory 652 can store program codes and data for the wireless device 600. The digital processor 630, controller/processor 650, and memory 652 can be implemented on one or more integrated circuits (ICs), application specific integrated circuits (ASICs), etc. By way of specific, non-limiting example, the digital processor 630 can be implemented on a Mobile Station Modem (MSM) ASIC.

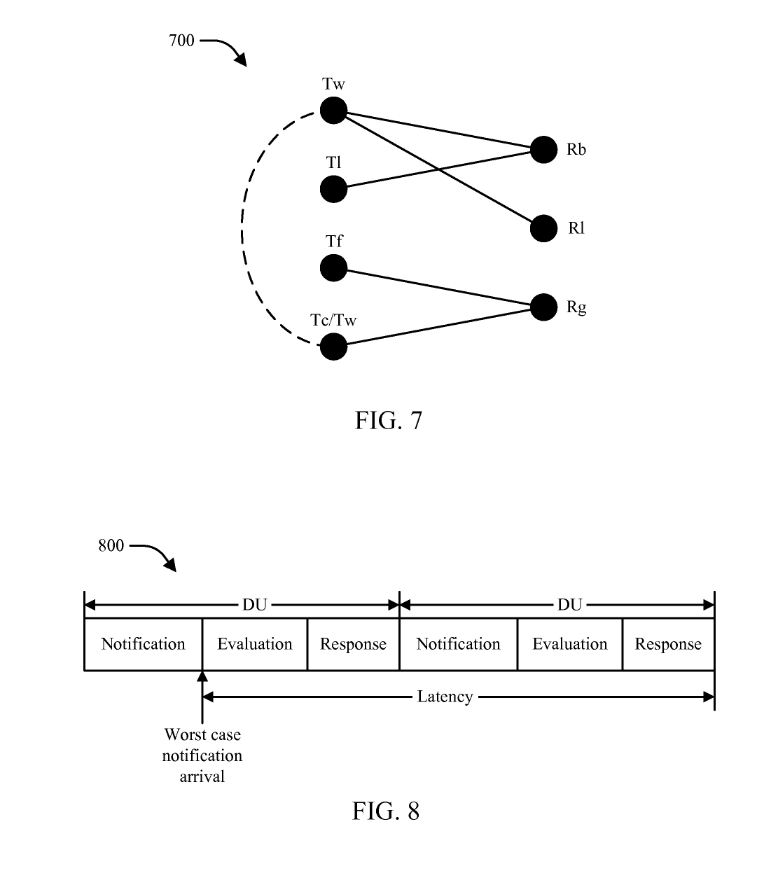

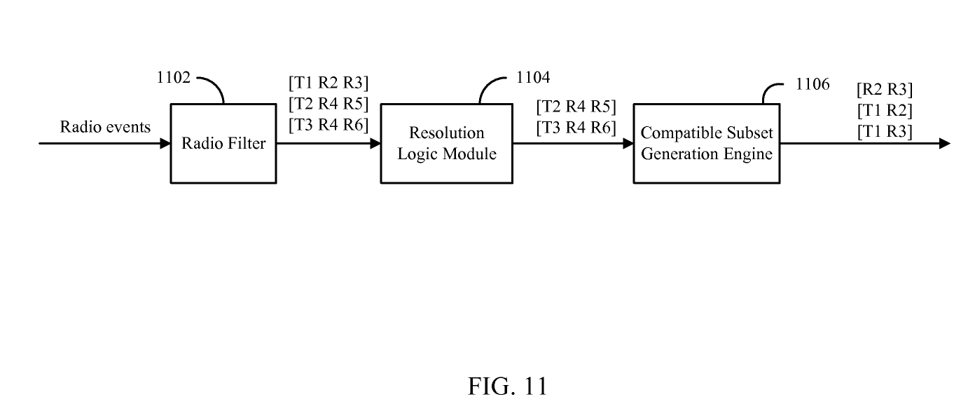

In an aspect, the CxM 640 can manage operation of respective radios 620 utilized by wireless device 600 in order to avoid interference and/or other performance degradation associated with collisions between respective radios 620. CxM 640 may perform one or more processes, such as those illustrated in FIG. 11. By way of further illustration, a graph 700 in FIG. 7 represents respective potential collisions between seven example radios in a given decision period. In the example shown in graph 700, the seven radios include a WLAN transmitter (Tw), an LTE transmitter (Tl), an FM transmitter (Tf), a GSM/WCDMA transmitter (Tc/Tw), an LTE receiver (Rl), a Bluetooth receiver (Rb), and a GPS receiver (Rg). The four transmitters are represented by four nodes on the left side of the graph 700. The four receivers are represented by three nodes on the right side of the graph 700.

A potential collision between a transmitter and a receiver is represented on the graph 700 by a branch connecting the node for the transmitter and the node for the receiver. Accordingly, in the example shown in the graph 700, collisions may exist between (1) the WLAN transmitter (Tw) and the Bluetooth receiver (Rb); (2) the LTE transmitter (Tl) and the Bluetooth receiver (Rb); (3) the WLAN transmitter (Tw) and the LTE receiver (Rl); (4) the FM transmitter (Tf) and the GPS receiver (Rg); (5) a WLAN transmitter (Tw), a GSM/WCDMA transmitter (Tc/Tw), and a GPS receiver (Rg).

In one aspect, an example CxM 640 can operate in time in a manner such as that shown by diagram 800 in FIG. 8. As diagram 800 illustrates, a timeline for CxM operation can be divided into Decision Units (DUs), which can be any suitable uniform or non-uniform length (e.g., 100 μs) where notifications are processed, and a response phase (e.g., 20 μs) where commands are provided to various radios 620 and/or other operations are performed based on actions taken in the evaluation phase. In one example, the timeline shown in the diagram 800 can have a latency parameter defined by a worst case operation of the timeline, e.g., the timing of a response in the case that a notification is obtained from a given radio immediately following termination of the notification phase in a given DU.

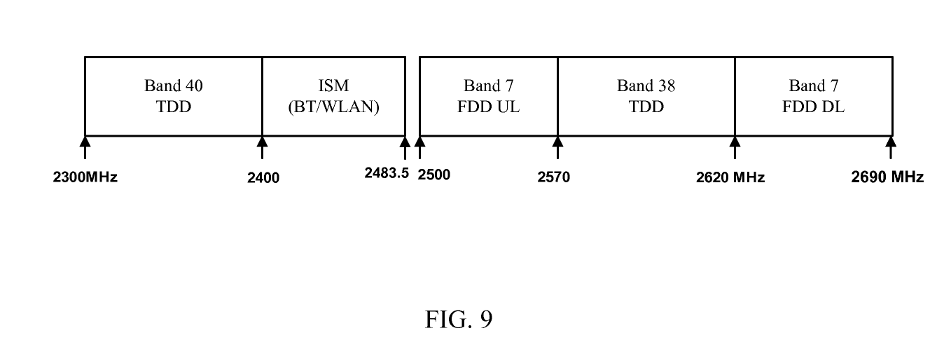

As shown in FIG. 9, Long Term Evolution (LTE) in band 7 (for frequency division duplex (FDD) uplink), band 40 (for time division duplex (TDD) communication), and band 38 (for TDD downlink) is adjacent to the 2.4 GHz Industrial Scientific and Medical (ISM) band used by Bluetooth (BT) and Wireless Local Area Network (WLAN) technologies. Frequency planning for these bands is such that there is limited or no guard band permitting traditional filtering solutions to avoid interference at adjacent frequencies. For example, a 20 MHz guard band exists between ISM and band 7, but no guard band exists between ISM and band 40.

To be compliant with appropriate standards, communication devices operating over a particular band are to be operable over the entire specified frequency range. For example, in order to be LTE compliant, a mobile station/user equipment should be able to communicate across the entirety of both band 40 (2300-2400 MHz) and band 7 (2500-2570 MHz) as defined by the 3rd Generation Partnership Project (3GPP). Without a sufficient guard band, devices employ filters that overlap into other bands causing band interference. Because band 40 filters are 100 MHz wide to cover the entire band, the rollover from those filters crosses over into the ISM band causing interference. Similarly, ISM devices that use the entirety of the ISM band (e.g., from 2401 through approximately 2480 MHz) will employ filters that rollover into the neighboring band 40 and band 7 and may cause interference.

In-device coexistence problems can exist with respect to a UE between resources such as, for example, LTE and ISM bands (e.g., for Bluetooth/WLAN). In current LTE implementations, any interference issues to LTE are reflected in the downlink measurements (e.g., Reference Signal Received Quality (RSRQ) metrics, etc.) reported by a UE and/or the downlink error rate which the eNB can use to make inter-frequency or inter-RAT handoff decisions to, e.g., move LTE to a channel or RAT with no coexistence issues. However, it can be appreciated that these existing techniques will not work if, for example, the LTE uplink is causing interference to Bluetooth/WLAN but the LTE downlink does not see any interference from Bluetooth/WLAN. More particularly, even if the UE autonomously moves itself to another channel on the uplink, the eNB can in some cases handover the UE back to the problematic channel for load balancing purposes. In any case, it can be appreciated that existing techniques do not facilitate use of the bandwidth of the problematic channel in the most efficient way.

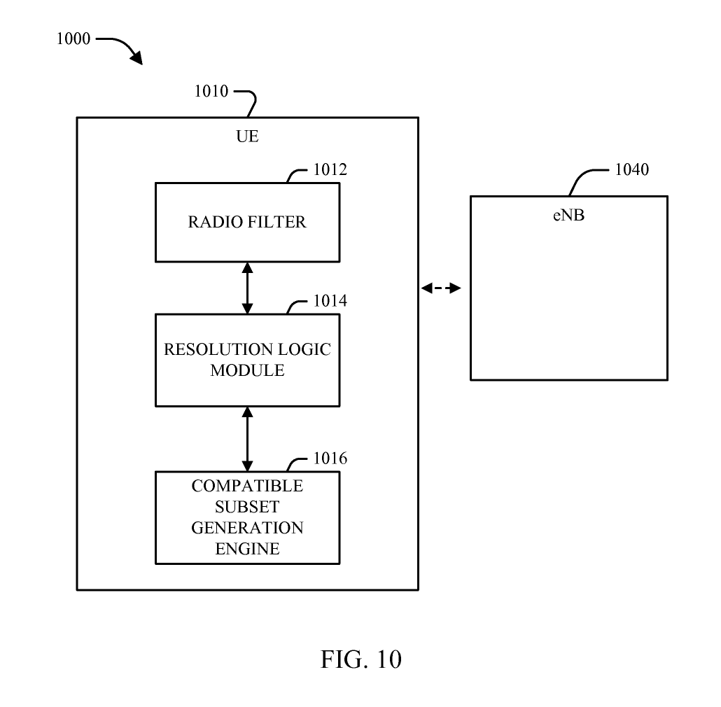

Turning now to FIG. 10, a block diagram of a system 1000 for providing support within a wireless communication environment for multi-radio coexistence management is illustrated. In an aspect, the system 1000 can include one or more UEs 1010 and/or eNBs 1040, which can engage in uplink and/or downlink communications, and/or any other suitable communication with each other and/or any other entities in the system 1000. In one example, the UE 1010 and/or eNB 1040 can be operable to communicate using a variety resources, including frequency channels and sub-bands, some of which can potentially be colliding with other radio resources (e.g., a broadband radio such as an LTE modem). Thus, the UE 1010 can utilize various techniques for managing coexistence between multiple radios utilized by the UE 1010, as generally described herein.

To mitigate at least the above shortcomings, the UE 1010 can utilize respective features described herein and illustrated by the system 1000 to facilitate support for multi-radio coexistence within the UE 1010. For example, a radio filter 1012, a resolution logic module 1014, and a compatible subset generation engine 1016 can be provided. The operation of modules 1012-1016 are described in detail below. The various modules 1012-1016 may, in some examples, be implemented as part of a coexistence manager such as the CxM 640 of FIG. 6. The various modules 1012-1016 and others may be configured to implement the aspects discussed herein.

Offered is a method and system for managing coexistence and interference between multiple radios on a mobile device, in particular a Long Term Evolution (LTE) radio and an Industrial Scientific and Medical (ISM) radio. Radio resources and events may be grouped into compatible subsets. Compatible subsets are groups of radio resources which may operate together without causing interference. Compatible subset generation occurs during an evaluation phase of a coexistence manager of a multi-radio device. Compatible subsets are determined by comparing operability of specific radios and components with other existing radios and components and logically progressing through various potential sets and subsets to determine which subsets are compatible. Compatible subsets are generated based on resolvability of radio events or other potential collisions of the subsets, such as by use of a progressive resolution graph, associated compatibility graphs, and instructions and logic corresponding to such graphs.

Compatible subsets are subsets of the radios which are able to coexist, for example, to operate concurrently, even under circumstances where the full set of radios cannot. One possible approach to the generation of compatible subsets is to identify pairs or triplets of radios that are not compatible with each other and hence, any larger set with these pairs or triplets will also not be compatible. In one aspect, the CxM 640 includes suitable programming, logic, or other instructions, to correlate compatibility between subsets of the radios associated with the radio events. Such correlation may include suitable operations to determine which of such subsets are maximally compatible, that is, which one or more subsets increase or maximize the number of events that can be supported simultaneously. Compatible subsets are also referred to as cliques, and maximal compatible subsets are referred to as maximal cliques.

In one manner of operation, the CxM 640 receives data, executes instructions, or otherwise performs steps to evaluate actual or potential collisions, interference, or performance degradation between respective radios 620, 721, such CxM evaluation being shown schematically in FIG. 11. The operations of the CxM 640 may occur during the evaluation phase of the decision unit shown in FIG. 8. By way of example, a radio filter 1102 may receive reports of radio events corresponding to interference, performance degradation, collisions, or the like, between respective radios. The radio filter 1102 may determine which radio combinations may be resolved without extensive further coexistence evaluation. As shown, transmit radios are represented by a T and receive radios are represented by a R. As shown in FIG. 11, three transmit radios are represented (T1-T3) and six receive radios are represented (R1-R6) (although R1 is not listed as potentially conflicting with another radio). Each specific radio access technology (such as LTE, WLAN, Bluetooth, etc.) may have one or more radios for transmit/receive purposes. These radios may be treated as separate transmit and receive radios for the purpose of determining compatible subsets as described herein. For example, T1 may correspond to the transmit radio for LTE whereas R1 may correspond to the receive radio for LTE.

The radio filter 1102 may determine what clusters of radios may be included in clusters which indicate which radios may be operable at the same time or may potentially be interfering with each other. For example, [T1 R2 R3] is one cluster indicating that transmit radio 1, receive radio 2 and receive radio 3 may potentially conflict. Other clusters are [T2 R4 R5] and [T3 R4 R6]. Radios which are not in a cluster with each other are not likely to interfere with each other. Thus, compatible subsets may be drawn from radios which are contained within a single cluster.

Resolution logic module 1104 executes further instructions to determine if there is a set of parameters (such as operational frequency, transmit power, time division, etc.) at each radio that can allow for the coexistence of the radio events of radios in a particular cluster. The result of operations of resolution logic module 1104 is a set of parameters to be used on respective, corresponding radios associated with the radio event to facilitate coexistence, or a determination that the radio events cannot coexist. As shown in FIG. 11, the clusters [T2 R4 R5] and [T3 R4 R6] indicate potential compatibility.

In the case of radio events related to a set of radios which cannot coexist, the CxM 640 in one implementation, includes a compatible subset generation engine 1106, and otherwise invokes methods and apparatus for compatible subset generation to facilitate multi-radio coexistence, as described below. For example, cluster [T1 R2 R3] did not pass the resolution logic module 1104, indicating that those radios do not have potential parameters making them all compatible together. Thus, cluster [T1 R2 R3] will be passed to the compatible subset generation engine 1106 to determine, what, if any, subsets of those radios may coexist. As shown in FIG. 11, [R2 R3] is a compatible subject, [T1 R2] is a compatible subset, and [T1 R3] is a compatible subset. Generally, the compatible subset with the largest number of compatible radios may be the preferred subset in a given situation. However, in certain situations, such as when multiple subsets feature the same number of radios, a determination may be made between those subsets as to the priority of which subset to use.

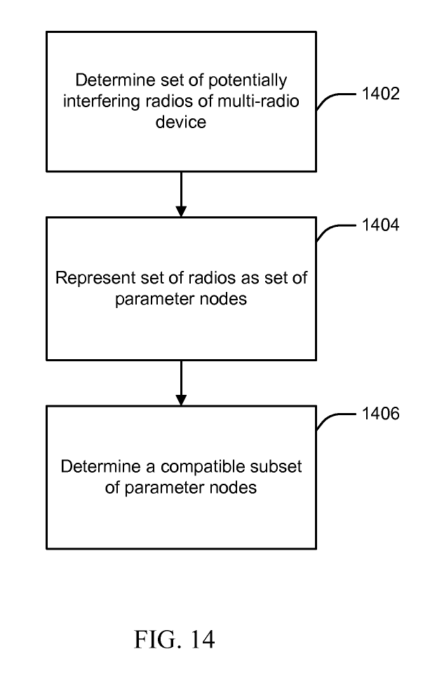

The following working examples, as well as the flow diagram of FIG. 14, illustrates an exemplary suitable sequence of operations of the CxM in performing the compatible subset generation, such as applying suitable instructions and algorithms to generate compatible subsets.

Compatible subsets may be represented graphically, where individual radios or operating modes of radios are represented by nodes and lines between the nodes represent compatibility between the respective connected radios or operating modes. For example, in a Progressive Resolution (PR) graph, each node represents an operating mode of a particular radio. An operating mode is a radio operating at certain parameters (such as a specific frequency, transmit power, etc.). Operating modes may also be called parameter settings. In a PR graph, each node represents an operating parameter of a radio. Connected lines between nodes mean that the connected nodes are compatible with each other and may operate simultaneously with reduced or no interference. In a second type of graph, called a compatibility graph, each node represents the radio itself. A group of connected nodes (called a clique) represents a compatible subset of radios (for a compatibility graph) or radio operating modes (for a PR graph).

A number of methods may be used to determine compatible subsets of radios/radio operating modes. Using a PR graph, a maximal clique (a clique with the largest possible number of connected nodes) may be determined using an algorithm such as a Bron-Kerbosch algorithm (described below). This may result in multiple combinations of the same radios but with different parameters. In certain situations (such as where there are many potential operating mode nodes for each radio) this may result in a complex and large graph.

Another method for determining compatible subsets includes starting with a compatibility graph and determining the compatibility edges between radios (based on information from the PR graph). This may be done in two ways. A first approach starts with a radio graph with no edges drawn and then adds compatibility edges to the graph. As these edges are added, a certain radio node may be split into multiple nodes based on the connectivity of its parameter nodes in the PR graph. A second approach starts by assuming all radio nodes are connected and edges are removed for radios that are not compatible with each other. Larger sets of radios may be broken up if they are not compatible, even if certain subsets may be compatible. Then an algorithm such as a Bron-Kerbosch algorithm (described below) may be run to determine a largest compatible subset. Examples of these methods are discussed and illustrated below.

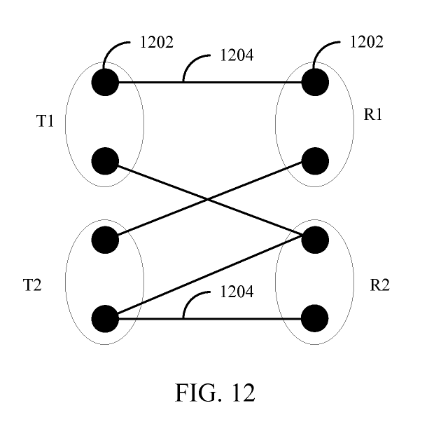

FIG. 12 shows a Progressive Resolution (PR) graph including two transmit radios T1 and T2, and two receive radios R1 and R2, with one radio event for each radio. Unlike the collision diagram of FIG. 7, the lines or edges 1204 between respective nodes 1202 of corresponding radios indicate compatibility rather than potential conflict or incompatibility of the radios. Each of the radios includes two parameter nodes 1202, which correspond to any of the various desirable operational characteristics of the radios which may or may not collide, interfere, or degrade in the presence of other radios. Such parameter settings may include operational frequency, transmit power, etc. Thus, a particular radio operating under particular parameter settings may be represented by a single node. Each relevant change to a parameter setting may result in a different parameter node for that radio. For purposes of illustration, only two nodes are shown for each radio, although more than two settings may result in more than two nodes for each radio. For example, if radio T1 is a Bluetooth transmit radio, the first node of T1 may be the Bluetooth transmit radio operating between 2410 and 2420 MHz at a certain power and the second node of T2 may be the Bluetooth transmit radio operating between 2410 and 2420 MHz at a different power.

According to the CxM configuration shown in FIG. 11, the resolution logic module 1104 would determine coexistence possibilities of the radio nodes pictured in FIG. 12. For the example of radios and radio nodes shown in FIG. 12, the four radios cannot coexist because, for example, there is no parameter node at R1 that can accommodate T1 and T2. However, one node of R1 can accommodate T1 and a different node of R1 can separately accommodate T2. Thus the radio sets expressed as T1R1 and T2R1 are compatible, while the radio set T1T2R1 is not compatible because there is no single node of R1 that is compatible with both T1 and T2.

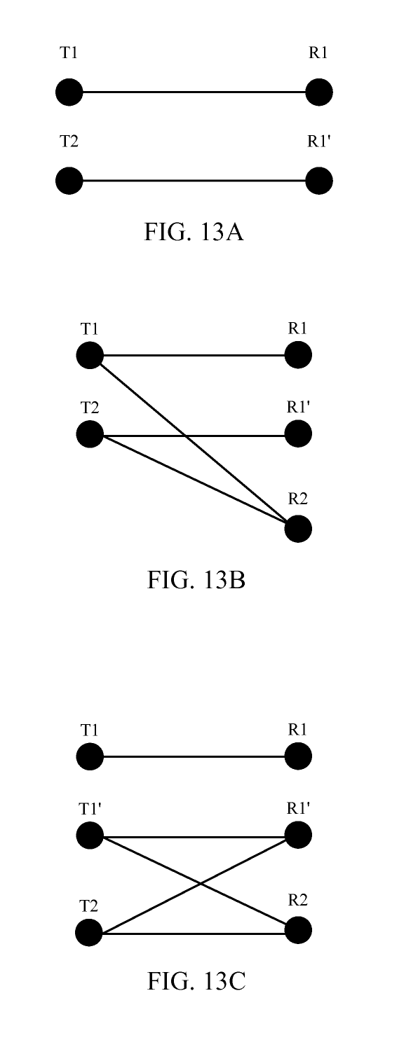

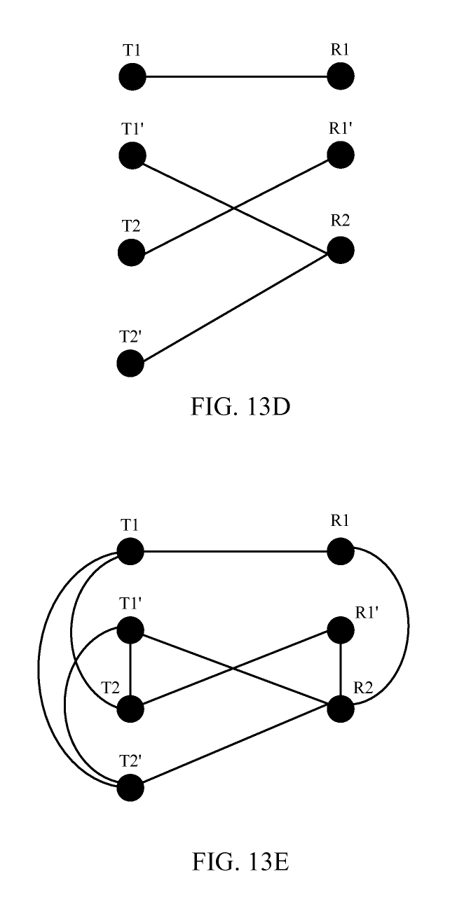

Continuing the illustration of the sets of radios and radio nodes shown in FIG. 12, the resolution logic module 1104 would then pass the PR graph of FIG. 12 and the non-compatible set T1T2R1 to the compatible subset generation engine 1106 to determine compatible subsets from the non-compatible set of radios T1T2R1. For each radio, the connectivity of each parameter node is checked by the compatible subset generation engine 1106 and a decision to split the radio occurs if there is no node that can support all the radios. For example, because individual nodes of R1 may separately be compatible with T1, the compatible pairs can be represented by splitting the node R1, and representing such split into two nodes, R1 and R1′ and representing such splitting in a compatibility graph shown in FIG. 13A where R1 is the node compatible with T1 and R1′ is the node compatible with T2. Suitable operations are performed to determine the cliques associated with a given set of radios. A cliques is a group of radios which are all connected. When radios or nodes are described as connected, depending on the context, the term “connected” generally refers to one or more parameters of the associated radio or node being compatible with, or capable of coexistence with, the other radio(s), node(s), or one or more corresponding parameters of the foregoing.

As seen in FIG. 13A, the corresponding edges between T1R1 and T2R1′ correspond to possible concurrent operation of a radio pair. The compatibility graph of FIG. 12 is further refined by repeating the above procedures at each of the radios. To ease the determination of compatible subsets, it may be preferable to reduce the number of parameter nodes for each radio (by considering only nodes that are compatible with a greater number of other radios), thereby making the calculations of compatible subsets less complicated. For example, as shown in FIG. 12, the first node of R2 can connect to T1 and T2 whereas the second node can only connect to T2. Because the first node of R2 connects to both transmit radios, R2 is not split. Rather, the first node of R2 is used and the second node of R2 is not used as the connectivity of the second node of R2 is duplicative of the connectivity of the first node of R2. Thus, only the first node of R2 is used and it is shown in FIG. 13B as connecting to both T1 and T2.

As for T1 of FIG. 12, however, its first node only connects to R1 whereas its second node only connects to R2. Thus, T1 is split into two nodes T1 and T1′. The connections of T1 and T1′ are shown in FIG. 13C. Similarly, neither node of T2 of FIG. 12 connects to both receive radios. The first node of T2 only connects to one node of R1 and the second node of T2 connects to two nodes of R2. Thus, T2 is also split into two nodes, called T2 and T2′. As shown in FIG. 13D, T2 connects to R1′ and T2′ connects to R2 (which, as noted above, is represented by a single node since R2 was not split).

Once the nodes of the radios are split, and a modified compatibility graph is created, the CxM 640 and compatible subset generation engine 1106 calculate the largest number of cliques available from the modified compatibility graph. The CxM 640 and compatible subset generation engine 1106 may be suitably programmed to apply various algorithms, including some described below, to the PR graph and associated compatibility graphs to determine such cliques, which represent compatible radio subsets.

One technique for determining such cliques is illustrated in FIG. 13E, where cliques are formed by including nodes which are always connected to each other, without connecting any of the split nodes X, X′. That is, transmit radios are always connected because they do not interfere with each other and receive radios are always connected because they do not interfere with each other, but different nodes from the same radio are not connected, because such nodes would not be operational at the same time. For example, as shown in FIG. 13E, T1 is connected to T2 and T2′, T1′ is connected to T2 and T2′, T2 is connected to T1 and T1′, and T2′ is connected to T1 and T1′. T1 is not connected to T1′ and T2 is not connected to T2′.

Once the compatibility graph is formed, such as that shown in FIGS. 13A-13E, the CxM may apply suitable methods to determine the maximal compatible subsets, which, in turn, correspond to the maximal cliques of the compatibility graph. One suitable method to be applied to generate compatible subsets of radios is the Bron-Kerbosch algorithm, including its variants, such as Algorithm 457, described in Finding All Cliques of an Un-Directed Graph, C. Bron and J. Kerbosch, Comm. ACM 16 (9): 575-577 (1973), the disclosure of which is expressly incorporated by reference herein in its entirety. Once the CxM 640 applies suitable methods, such as the Bron-Kerbosch algorithm and its variants, compatible subsets of radios are generated and concurrent operation of the radios of such subsets is less likely to generate undesirable degradation, collisions, or interference in operations of associated multi-radio devices.

In one aspect, a general method for determining a radio compatibility graph with S radios may be implemented as follows. (1) Let s be the number of the radio presently being operated on. Set s=1 and start with the first radio in the PR graph, i.e., set Qₛ=Q₁. (2) Determine the sets of radios connected to each of the nodes of the first radio Qₛ; denote those connected radio sets by A₁ to Aₙ. In the example above, let Qₛ be R₁, then A₁={T₁}, A₂={T₂}. (3) As a subset step, if Aᵢ is a subset of Aₖ, eliminate Aᵢ. This will remove from the calculations any nodes whose connectivity is duplicated by more connected nodes. (For example, removing the second node of R2 described above in reference to FIGS. 12 and 13B.) Let the surviving sets be B₁ to B_{K}. (4) Among the remaining nodes, they are split into individual radios. That is, split Qₛ into K sub-nodes, Qₛ₁ to Q_{sK}. (5) Next, the connectivity of the split nodes is determined. These nodes are connected to radios that have already been analyzed and radios that have yet to be analyzed according to this method. For k=1:K (determine the radio nodes to be connected to Qₛₖ):

```
Let Ωₛₖ={ }
  For Q_{z} ε Bₖ
    a. Define z to be from 1 to the total number of radios, where z ≠ s.
        If z>s, Ωₛₖ = Ωₛₖ U {Q_{z}} (radio has not been analyzed yet)
    b. Else, if z<s (radio already analyzed)
        i. Denote the previously generated sub-nodes of Q_{z} as Q_{z1} to
        Q_{zM}
        ii. For i =1 to M
          If Q_{zi} is connected to Qₛ in the compatibility graph, Ω ₛₖ =
          Ω ₛₖ U {Q_{zi}}
```

(6) Then connect Qₛₖ to every node in Ωₛₖ for every k. (7) Increment to the next radio by making s=s+1. If s≠S, repeat steps 2 to 6, otherwise the method is complete. In the above method, steps 2-3 exclude some parameter nodes at each radio for determining compatibility and step 4-6 split the radio node and determine its connections to the other radio nodes in the compatibility graph. The above method is based on checking the connectivity at each parameter node.

Some multi-radio applications are more suitable to an alternate method of determining compatible radio subsets. Such alternative methods may be devised so that, in most cases, they should be able to identify radio pairs that are incompatible. For example, after a power resolution algorithm, the minimum power required for a particular transmitter may be compared with the power required for supporting each receiver connected to this transmitter. If the power required to support a receiver is lower than the minimum power required, that particular transmit-receive pair may be determined to be incompatible. More generally, it can be determined if each (transmit-receive) pair of radios in the PR graph is compatible and not connect them in the compatibility graph.

The above-described operations are one suitable approach to the CxM evaluating radio events which may result in collisions, interference, degradation and the like, and in generating compatible subsets of radios that can nonetheless operate concurrently. Given the many applications of multi-radio devices, including LTE user equipment, additional or alternate methods and techniques may be employed by the CxM 640 to evaluate radio events and generate compatible subsets. So, for example, in cases where subsets of radios could be compatible without the superset being compatible, whether to split parameter nodes in the compatibility graph can be checked by running the PR algorithm on the superset. If the superset is not compatible, but subsets are, the superset is split into subsets. While running the PR algorithm and checking whether nodes for a particular radio can be used under such algorithm, the CxM 640 may verify if there is another radio to which none of the nodes are connected. If so, then a pair of radios that cannot coexist has been identified, and this pair will not have an edge in the associated compatibility graph.

When subsets of radios are compatible but the entire set is not, the PR algorithm can be run for only the subsets to determine if the subsets can coexist. If all the subsets of a given set of radios can coexist, but the set itself cannot coexist, one of the radios may be split into a combination of C-1 radios, where C is the size of the combination. Then, each split is connected to all but one of the remaining nodes in this combination. Each split also inherits all the edges of the radios which are not part of this combination from the original node.

In the examples discussed above, subsets of radios could be compatible without the superset being compatible. In FIG. 12, T1R1 and T2R1 are compatible but T1T2R1 are not compatible. The combinations where this is likely to happen may be determined in advance. Moreover, the size of such combinations is likely to be small in practice, typically limited to three or four radios. In such cases, a CxM can explicitly check to see if it should split nodes in the compatibility graph by running the PR algorithm on smaller subsets. In this alternate aspect, a general algorithm would be as follows:

1. While running the PR algorithm and checking the usability of nodes for a particular radio, check if there is another radio to which none of the nodes are connected. This identifies a pair of radios that cannot co-exist and this pair will not have an edge in the compatibility graph.

2. For each combination of radios for which the subsets are all compatible but the entire set may be incompatible,
a. Run the PR algorithm for only this combination to determine if the combination can co-exist.
b. If all of the subsets of the combination can co-exist but the combination itself cannot coexist, then split one of the radios in the combination into C-1 radios, where C is the size of the combination. For example, if C=4 and the radios are X₁X₂X₃X₄, X₁ can be split into X₁₁, X₁₂, and X₁₃.
c. Connect each split to all but one of the remaining nodes in this combination. In the above example, the connections would be X ₁₁X₂X₃, X₁₂X₂X₄, and X₁₃X₃X₄.
d. Connect each split node to all the radios that are not in this combination, and which were connected to the original node.

In most cases, C will be limited to 3 or 4 and the complexity of the algorithm should be manageable. Note also that the first step above is a special case of the general step 2 with C=2, so that no splitting is needed and the edge between the radios is just removed.

Once the compatibility graph is formed, the maximal compatible subsets correspond to the maximal cliques of the graph. As mentioned earlier, finding maximal cliques in the graph theory literature may be accomplished by the Bron-Kerbosch (BK) algorithm and its variants. The BK algorithm starts from a node in the compatibility graph and determines all the maximal cliques that contain that node in a recursive manner. Let V[G] denote the set of n nodes of the graph G and N[ui] denote the set of neighbors to the node ui, i.e. the set of nodes connected to ui in G. The following description of the algorithm is from F. Cazals and C. Karande, A note on the problem of reporting maximal cliques, Theoretical Computer Science, January 2008, the disclosure of which is expressly incorporated by reference herein in its entirety.

```
Algorithm call: BK(_{φ},V[G], _{φ}).
BK(R, P, X):
      if P = _{φ} and X = _{φ} then
        Report R as a maximal clique
      else
        Assume P = {u₁,u₂, ...,uₖ}
        for i = 1 to k do
          P = P − {uᵢ}
          R_{new} = R _{∪} {uᵢ}
          P_{new} = P _{∩} N[uᵢ]
          X_{new} = X _{∩} N[uᵢ]
          BK(R_{new}, P_{new}, X_{new})
          X = X _{∪} {uᵢ}
```

Here, R denotes the set of nodes that is the clique being constructed (and will be reported eventually as maximal clique), P denotes that nodes that can be potentially added to R to enlarge the clique, and X denotes the set of nodes having maximal cliques already found. One step is where the set of potential clique nodes P is reduced by considering only the neighbors of the node that has been added (Pnew=P ∩ N[ui]). This step ensures that each node that is being added to R is connected to all the existing nodes in R. When there are no more nodes that can be added (P=φ) and no duplicates being produced (X=φ), R is reported as a maximal clique. Cazals and Karande discuss further details and a variant of this method where the number of recursions is reduced by choosing a pivot node in P and running the recursion only for non-neighbors of the pivot. There are other alternatives and variations to the BK algorithm which may likewise be suitably applied to generate compatible subsets for multi-radio devices.

When compatible subsets have been determined for a multi-radio device as described above, a CxM 640 may use the determined subsets to operate the multi-radio device efficiently to reduce cross-radio interference. The CxM may check a priority of the compatible subsets and may select one with a highest priority. Priority may be based on communication conditions, internal radio operation, or a number of other factors.

As shown in FIG. 14, a coexistence manager may determine a set of radios of a multi-radio device that may potentially interfere with each other as shown in block 1402. The coexistence manager may also represent the set of radios as a set of parameter nodes as shown in block 1404. Each parameter node represents a communication configuration of one of the set of radios. The coexistence manager may also determine a subset of parameter nodes as shown in block 1406. The subset includes parameter nodes representing radio communication configurations that are compatible with each other.

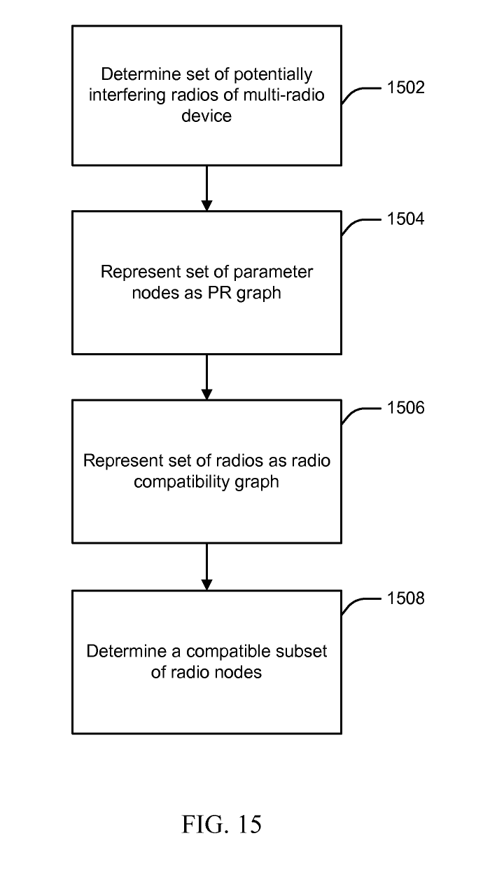

As shown in FIG. 15, a coexistence manager may determine a set of radios of a multi-radio device that may potentially interfere with each other as shown in block 1502. The coexistence manager may represent a set of parameter nodes as a progressive resolution graph as shown in block 1504. Each parameter node represents a communication configuration of one of the set of radios. The coexistence manager may represent the set of radios as a radio compatibility graph as shown in block 1506. Each radio node represents one of the set of radios. The coexistence manager may determine a subset of radio nodes based on at least one of the radio compatibility graph and the progressive resolution graph as shown in block 1508. The subset includes radio nodes representing radios that are compatible with each other.

In one configuration, a UE 120 is configured for wireless communication including means for determining a set of radios of a multi-radio device that may potentially interfere with each other, means for representing the set of radios as a set of parameter nodes, each parameter node representing a communication configuration of one of the set of radios, and means for determining a subset of parameter nodes, the subset including parameter nodes representing radio communication configurations that are compatible with each other. In one aspect, the means may be the antennae 252, the receive data processor 260, the processor 270, the coexistence manager 640, the radio filter 1102, the resolution logic module 1014 or 1104, and/or the compatible subset generation engine 1016 or 1106. In another aspect, the aforementioned means may be a module or any apparatus configured to perform the functions recited by the aforementioned means.

In one configuration, a UE 120 is configured for wireless communication including means for determining a set of radios of a multi-radio device that may potentially interfere with each other, means for representing a set of parameter nodes as a progressive resolution graph, each parameter node representing a communication configuration of one of the set of radios, means for representing the set of radios as a radio compatibility graph, each radio node representing one of the set of radios, and means for determining a subset of radio nodes based on at least one of the radio compatibility graph and the progressive resolution graph, the subset including radio nodes representing radios that are compatible with each other. In one aspect, the means may be the antennae 252, the receive data processor 260, the processor 270, the coexistence manager 640, the radio filter 1102, the resolution logic module 1014 or 1104, and/or the compatible subset generation engine 1016 or 1106. In another aspect, the aforementioned means may be a module or any apparatus configured to perform the functions recited by the aforementioned means.

The examples above describe aspects implemented in an LTE system. However, the scope of the disclosure is not so limited. Various aspects may be adapted for use with other communication systems, such as those that employ any of a variety of communication protocols including, but not limited to, CDMA systems, TDMA systems, FDMA systems, and OFDMA systems.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method of wireless communication, the method comprising:
determining a set of radios of a multi-radio device that may potentially interfere with each other;
representing the set of radios as a set of parameter nodes, each parameter node representing a communication configuration of one of the set of radios; and
determining a subset of parameter nodes, the subset including parameter nodes representing radio communication configurations that are compatible with each other.

2. The method of claim 1 further comprising determining a subset containing a maximum number of compatible parameter nodes from a cluster of radios not completely compatible with each other.

3. The method of claim 2, further comprising applying a Bron-Kerbosch algorithm to determine the subset containing the maximum number of compatible parameter nodes.

4. The method of claim 1 executed during an evaluation phase of a co-existence manager operatively associated with the multi-radio device.

5. The method of claim 1, in which the determining a subset of parameter nodes comprises excluding nodes having connectivity to no other nodes.

6. An apparatus for wireless communications, comprising:
means for determining a set of radios of a multi-radio device that may potentially interfere with each other;
means for representing the set of radios as a set of parameter nodes, each parameter node representing a communication configuration of one of the set of radios; and
means for determining a subset of parameter nodes, the subset including parameter nodes representing radio communication configurations that are compatible with each other.

7. A computer program product configured for wireless communication, the computer program product comprising:
a non-transitory computer-readable medium having non-transitory program code recorded thereon, the non-transitory program code comprising:
program code to determine a set of radios of a multi-radio device that may potentially interfere with each other;
program code to represent the set of radios as a set of parameter nodes, each parameter node representing a communication configuration of one of the set of radios; and
program code to determine a subset of parameter nodes, the subset including parameter nodes representing radio communication configurations that are compatible with each other.

8. An apparatus configured for wireless communication, the apparatus comprising:
a memory; and
at least one processor coupled to the memory, the at least one processor being configured:
to determine a set of radios of a multi-radio device that may potentially interfere with each other;
to represent the set of radios as a set of parameter nodes, each parameter node representing a communication configuration of one of the set of radios; and
to determine a subset of parameter nodes, the subset including parameter nodes representing radio communication configurations that are compatible with each other.

9. The apparatus of claim 8 in which the at least one processor is further configured to determine a subset containing a maximum number of compatible parameter nodes from a cluster of radios not completely compatible with each other.

10. The apparatus of claim 9 in which the at least one processor is further configured to apply a Bron-Kerbosch algorithm to determine the subset containing the maximum number of compatible parameter nodes.

11. The apparatus of claim 8 in which the at least one processor is configured to operate during an evaluation phase of a co-existence manager operatively associated with the multi-radio device.

12. The apparatus of claim 8, in which the at least one processor is configured to determine a subset of parameter nodes by excluding nodes having connectivity to no other nodes.

13. A method of wireless communication, the method comprising:
determining a set of radios of a multi-radio device that may potentially interfere with each other;
representing a set of parameter nodes as a progressive resolution graph, each parameter node representing a communication configuration of one of the set of radios;
representing the set of radios as a radio compatibility graph, each radio node representing one of the set of radios; and
determining a subset of radio nodes based on at least one of the radio compatibility graph and the progressive resolution graph, the subset including radio nodes representing radios that are compatible with each other.

14. The method of claim 13 further comprising determining edges in the radio compatibility graph from connectivity of parameter nodes in the progressive resolution graph.

15. The method of claim 13 further comprising splitting a first radio node into multiple new radio nodes, each new radio node representing a subset of communication configurations of a radio of the first radio node.

16. The method of claim 15 further comprising excluding a new radio node split from the first radio node having connectivity that is a subset of connectivity of another new radio node of the first radio node when forming edges of the radio compatibility graph.

17. The method of claim 13 further comprising determining a subset containing a maximum number of compatible radio nodes from a cluster of radios not completely compatible with each other.

18. The method of claim 17, further comprising applying a Bron-Kerbosch algorithm to determine the subset containing the maximum number of compatible radio nodes.

19. The method of claim 13 executed during an evaluation phase of a co-existence manager operatively associated with the multi-radio device.

20. An apparatus for wireless communications, comprising:
means for determining a set of radios of a multi-radio device that may potentially interfere with each other;
means for representing a set of parameter nodes as a progressive resolution graph, each parameter node representing a communication configuration of one of the set of radios;
means for representing the set of radios as a radio compatibility graph, each radio node representing one of the set of radios; and
means for determining a subset of radio nodes based on at least one of the radio compatibility graph and the progressive resolution graph, the subset including radio nodes representing radios that are compatible with each other.

21. A computer program product configured for wireless communication, the computer program product comprising:
a non-transitory computer-readable medium having non-transitory program code recorded thereon, the non-transitory program code comprising:
program code to determine a set of radios of a multi-radio device that may potentially interfere with each other;
program code to represent a set of parameter nodes as a progressive resolution graph, each parameter node representing a communication configuration of one of the set of radios;
program code to represent the set of radios as a radio compatibility graph, each radio node representing one of the set of radios; and
program code to determine a subset of radio nodes based on at least one of the radio compatibility graph and the progressive resolution graph, the subset including radio nodes representing radios that are compatible with each other.

22. An apparatus configured for wireless communication, the apparatus comprising:
a memory; and
at least one processor coupled to the memory, the at least one processor being configured:
to determine a set of radios of a multi-radio device that may potentially interfere with each other;
to represent a set of parameter nodes as a progressive resolution graph, each parameter node representing a communication configuration of one of the set of radios;
to represent the set of radios as a radio compatibility graph, each radio node representing one of the set of radios; and
to determine a subset of radio nodes based on at least one of the radio compatibility graph and the progressive resolution graph, the subset including radio nodes representing radios that are compatible with each other.

23. The apparatus of claim 22 in which the at least one processor is further configured to determine edges in the radio compatibility graph from connectivity of parameter nodes in the progressive resolution graph.

24. The apparatus of claim 22 in which the at least one processor is further configured to split a first radio node into multiple new radio nodes, each new radio node representing a subset of communication configurations of a radio of the first radio node.

25. The apparatus of claim 24 in which the at least one processor is further configured to exclude a new radio node split from the first radio node having connectivity that is a subset of connectivity of another new radio node of the first radio node when forming edges of the radio compatibility graph.

26. The apparatus of claim 22 in which the at least one processor is further configured to determine a subset containing a maximum number of compatible radio nodes from a cluster of radios not completely compatible with each other.

27. The apparatus of claim 26, in which the at least one processor is further configured to apply a Bron-Kerbosch algorithm to determine the subset containing the maximum number of compatible radio nodes.

28. The apparatus of claim 22 in which the at least one processor is configured to operate during an evaluation phase of a co-existence manager operatively associated with the multi-radio device.
